(19) United States
(12) Patent Application Publication
(10) Pub. No.: US 2006/0172908 A1
(43) Pub. Date: Aug. 3, 2006

(54) Dishwashing detergent composition

(75) Inventors: Veronique Willy Francoise Everaert, Ternat (BE); Tania Patricia Maddox, Overijse (BE); Eric Tcheou, Brussels (BE)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/298,414

(22) Filed: Dec. 8, 2005

(30) Foreign Application Priority Data
Dec. 21, 2004 (EP) 04078450.6

(51) Int. Cl. C11D 3/20

(52) U.S. Cl. 510/235

(57) ABSTRACT

A detergent composition is disclosed that contains an alkyl ethoxylate sulfate surfactant having an average ethoxylation level of from 1 to 5, and amine oxide. The amine oxide is present in an amount from 1% to 8.5%, by weight of the composition. The detergent composition has a pH from 5.5 to 8.5. The combined level of any free fatty alcohols and sulfated alcohols in the detergent composition is less than 3% by weight of the composition.

### TECHNICAL FIELD

The present invention relates to detergent compositions, especially dishwashing detergent compositions.

### BACKGROUND TO THE INVENTION

Alkyl ethoxylate sulfate surfactants and amine oxides are typical ingredients in dishwashing compositions. The combination of both ingredients provides a cost-effective cleaning and sudsing system. Dishwashing compositions comprising alkyl ethoxylate sulfate surfactants in combination with amine oxides, especially when the amine oxides are present at elevated levels, are typically formulated at higher pH (a pH of 9, or higher) to provide stable compositions at low temperature (as low as −5° C.). A high pH is however not desired for compositions which come in contact with the skin during use.

To formulate compositions comprising alkyl ethoxylate sulfate surfactants and amine oxides, at a lower pH (a pH of less than 9), additional ingredients are typically required (such as hydrotropes) to ensure that the composition is stable at low temperatures. This results in more expensive formulations.

As such, it is an object of the present invention to provide cost-effective dishwashing detergent compositions comprising alkyl ethoxylate sulfate surfactants and amine oxides, having a pH of less than 9, and which have good grease-cleaning properties, and are stable at low temperatures for a long period.

It is another object of the present invention to provide dishwashing detergent compositions comprising alkyl ethoxylate sulfate surfactants and elevated levels of amine oxides, which are stable at low temperatures for a long period.

It is also an object of the present invention to provide dishwashing detergent compositions having improved rinse feel properties.

### SUMMARY OF THE INVENTION

According to the present invention there is provided a dishwashing detergent composition comprising:
an alkyl ethoxylate sulfate surfactant having an average ethoxylation level of from 1 to 5; and
from 1.0% to 8.5%, by weight of said composition, of amine oxide;
and said composition having a pH from 5.5 to 8.5;
   characterized in that said composition comprises a combined level of free fatty alcohols and sulfated alcohols of less than 3% by weight of said composition.

According to another aspect of the present invention, there is provided a process of cleaning dishware.

### DETAILED DESCRIPTION OF THE INVENTION

All percentages, ratios and proportions herein are by weight of the final dishwashing composition, unless otherwise specified. All temperatures are in degrees Celsius (° C.) unless otherwise specified.

As used herein, the term “dish” means any dishware, tableware, cookware, glassware, cutlery, cutting board, food preparation equipment, etc. which is washed prior to or after contacting food, being used in a food preparation process and/or in the serving of food.

As used herein, the terms “foam” and “suds” are used interchangeably and indicate discrete bubbles of gas bounded by and suspended in a liquid phase.

As used herein, the term “rinse feel” relates to the slippery feeling to the hands of the user and the dishware. Improved rinse feel means that the feeling of slipperiness is reduced.

The cleaning composition may be in any suitable form, for example gel or liquid. The cleaning composition is preferably in liquid form. Moreover the cleaning composition is preferably in liquid aqueous form. Where present, water is preferably present at a level of from 30% to 80% by weight of the cleaning composition, more preferably from 40% to 70% and most preferably from 45% to 65%.

The dishwashing detergent composition of the present invention comprises an alkyl ethoxylate sulfate surfactant, and an amine oxide. The composition has a pH from 5.5 to 8.5, preferably from 6 to 8.

Amine Oxide

The dishwashing detergent composition of the present invention comprises amine oxide. Amine oxides are semi-polar nonionic surfactants and include water-soluble amine oxides containing one alkyl moiety of from 10 to 18 carbon atoms and 2 moieties selected from the group consisting of alkyl groups and hydroxyalkyl groups containing from 1 to 3 carbon atoms; water-soluble phosphine oxides containing one alkyl moiety of from 10 to 18 carbon atoms and 2 moieties selected from the group consisting of alkyl groups and hydroxyalkyl groups containing from 1 to 3 carbon atoms; and water-soluble sulfoxides containing one alkyl moiety of from 10 to 18 carbon atoms and a moiety selected from the group consisting of alkyl and hydroxyalkyl moieties of from 1 to 3 carbon atoms. Preferred amine oxide surfactants in particular include C₁₀-C₁₈ alkyl dimethyl amine oxides and C₈-C₁₂ alkoxy ethyl dihydroxy ethyl amine oxides. Most preferred amine oxide is C₁₂₋₁₄ dimethyl amine oxide. Another highly preferred amine oxide for use in the composition of the present invention, is cocoamido-3-propyldimethylamine oxide.

The amine oxide of the present invention is present in an amount of from 1% to 8.5%, preferably in an amount from 2% to 8.5%, even more preferably from 4% to 8.5%, and most preferably from 5% to 8.5%, by weight of the composition. The amine oxide is used in conjunction with the alkyl ethoxy sulfate surfactant of the present invention at a weight ratio of amine oxide to alkyl ethoxy sulfate surfactant of from 0.2 to 0.4, preferably from 0.25 to 0.35.

Alkyl Ethoxylate Sulfate Surfactant

The dishwashing detergent composition of the present invention also comprises an alkyl ethoxylate sulfate surfactant, represented by the formula:
RO(CH₂CH₂O)ₓSO₃M
wherein

R represents an alkyl group having 8 to 16 carbon atoms, preferably from 12 to 14 carbon atoms,

x is the average ethoxylation level (i.e. x is the average number of ethylene oxide units), and

M is H or a cation which can be, for example, a metal cation (e.g., sodium, potassium, lithium, etc.), ammonium or substituted-ammonium cation. Specific examples of substituted ammonium cations include methyl-, dimethyl-, trimethyl-ammonium and quaternary ammonium cations, such as tetramethyl-ammonium, dimethyl piperidinium and cations derived from alkanolamines, e.g. monoethanolamine, diethanolamine, and triethanolamine, and mixtures thereof.

It has been surprisingly found that alkyl ethoxylates sulfate surfactants having an average ethoxylation level (x) of from 1 to 5, preferably from 1 to 4, more preferably from 1.5 to 3.5, and most preferably from 2 to 3, and a low combined level of free fatty alcohol and sulfated alcohol, provide the desired low temperature stability when used in combination with elevated levels of amine oxides. The combined level of free fatty alcohol and sulfated alcohol is less than 3%, preferably less than 2.5%, more preferably less than 2%, and most preferably less than 1.5%, by weight of the composition.

It is preferred that the alkyl ethoxy sulfate surfactant has a narrow ethoxylates range. Narrow range ethoxylates use a different manufacturing process to typical broad range ethoxylates. The process results in ethoxylated alcohols with a lower level of unreacted alcohol, typically a lower level of low molecular weight ethoxylated units and a lower level of high molecular weight ethoxylated units versus the desired target ethoxylation level. The absolute changes versus the broad range ethoxylated alcohols is dependent on the average ethoxylation and the process used to manufacture the narrow range material.

“Narrow ethylene oxide distribution” means that at least 50% by weight of the surfactant, preferably 60% or greater, contains polyethoxy groups which are within about 3 ethoxy groups of the average number of ethylene oxide units. However, it is highly desirable that no more than 70% of the polyoxyethylene groups have the same length since to provide very pure materials for detergent compositions is economically unfeasible.

Optional Ingredients

The compositions of the present invention may also comprise optional ingredients for example additional surfactants, hydrotrope, viscosity modifier, diamine, polymeric suds stabiliser, enzymes, builder, perfume, chelating agent and mixtures thereof.

Surfactant

Additional surfactants may be selected from the group consisting of amphoteric, nonionic, anionic, cationic surfactants and mixtures thereof. Suitable surfactants are those commonly used in detergent compositions.

The composition of the present invention may optionally comprise an additional amphoteric surfactant, different from the amine oxides described hereinabove. Suitable, non-limiting examples of amphoteric detergent surfactants, that are useful in the present invention include derivatives of aliphatic or heterocyclic secondary and ternary amines in which the aliphatic moiety can be straight chain or branched and wherein one of the aliphatic substituents contains from 8 to 24 carbon atoms and at least one aliphatic substituent contains an anionic water-solubilizing group. Preferably the additional amphoteric surfactant, when present, is present in the composition in an effective amount, more preferably from 0.1% to 20%, even more preferably 0.1% to 15%, even more preferably still from 0.5% to 10% by weight. However, the composition of the present invention is preferably free of betaines.

The composition of the present invention can optionally comprise additional anionic surfactants, different from the alkyl ethoxylates sulfate surfactants described hereinabove. Suitable anionic surfactants for use in the compositions herein include water-soluble salts or acids of C₆-C₂₀ linear or branched hydrocarbyl, preferably an alkyl, hydroxyalkyl or alkylaryl, having a C₁₀-C₂₀ hydrocarbyl component, more preferably a C₁₀-C₁₄ alkyl or hydroxyalkyl, sulfate or sulphonate. Suitable counterions include H, alkali metal cation or ammonium or substituted ammonium, but preferably sodium.

Where the hydrocarbyl chain is branched, it preferably comprises C₁₋₄ alkyl branching units. The average percentage branching of the anionic surfactant is preferably greater than 30%, more preferably from 35% to 80% and most preferably from 40% to 60%. The additional anionic surfactant is preferably present at a level of at least 15%, more preferably from 20% to 40% and most preferably from 25% to 40% by weight of the total composition.

Suitable nonionic surfactants for use in the composition of the present invention, include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 20 carbon atoms with from 2 to 18 moles of ethylene oxide per mole of alcohol. The preferred alkylpolyglycosides have the formula R²O(CₙH₂ₙO)ₜ(glycosyl)ₓ, wherein R² is selected from the group consisting of alkyl, alkyl-phenyl, hydroxyalkyl, hydroxyalkylphenyl, and mixtures thereof in which the alkyl groups contain from 10 to 18, preferably from 12 to 14, carbon atoms; n is 2 or 3, preferably 2; t is from 0 to 10, preferably 0; and x is from 1.3 to 10, preferably from 1.3 to 3, most preferably from 1.3 to 2.7. The glycosyl is preferably derived from glucose. To prepare these compounds, the alcohol or alkylpolyethoy alcohol is formed first and then reacted with glucose, or a source of glucose, to form the glucoside (attachment at the 1-position). The additional glycosyl units can then be attached between their 1-position and the preceding glycosyl units 2-, 3-, 4- and/or 6-position, preferably predominantly the 2-position.

Fatty acid amide surfactants having the formula: 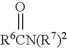
wherein R⁶ is an alkyl group containing from 7 to 21 (preferably from 9 to 17) carbon atoms and each R⁷ is selected from the group consisting of hydrogen, C₁-C₄ alkyl, C₁-C₄ hydroxyalkyl, and —(C²H₄O )ₓH where x varies from 1 to 3. Preferred amides are C₈-C₂₀ ammonia amides, monoethanolamides, diethanolamides, and isopropanolamides.

Preferably the nonionic surfactant, when present in the composition, is present in an effective amount, more preferably from 0.1% to 20%, even more preferably 0.1% to 15%, even more preferably still from 0.5% to 10%,by weight.

Viscosity Modifier

The composition of the present invention may optionally comprise a viscosity modifier. Suitable viscosity modifiers include lower alkanols, glycols, C4-14 ethers and diethers, glycols or alkoxylated glycols, alkoxylated aromatic alcohols, aromatic alcohols, aliphatic branched alcohols, alkoxylated aliphatic branched alcohols, alkoxylated linear C1-C5 alcohols, linear C1-C5 alcohols, amines, C8-C14 alkyl and cycloalkyl hydrocarbons and halohydrocarbons, C6-C16 glycol ethers and mixtures thereof.

Preferred viscosity modifiers are selected from methoxy octadecanol, ethoxyethoxyethanol, benzyl alcohol, 2-ethylbutanol and/or 2-methylbutanol, 1-methylpropoxyethanol and/or 2-methylbutoxyethanol, linear C₁-C₅ alcohols such as methanol, ethanol, propanol, isopropanol, butyl diglycol ether (BDGE), butyltriglycol ether, ter amilic alcohol, glycerol and mixtures thereof. Particularly preferred viscosity modifiers which can be used herein are butoxy propoxy propanol, butyl diglycol ether, benzyl alcohol, butoxypropanol, propylene glycol, glycerol, ethanol, methanol, isopropanol and mixtures thereof.

Other suitable viscosity modifiers for use herein include propylene glycol derivatives such as n-butoxypropanol or n-butoxypropoxypropanol, water-soluble CARBITOL R viscosity modifiers or water-soluble CELLOSOLVE R viscosity modifiers; water-soluble CARBITOL R viscosity modifiers are compounds of the 2-(2-alkoxyethoxy)ethanol class wherein the alkoxy group is derived from ethyl, propyl or butyl; a preferred water-soluble carbitol is 2-(2-butoxyethoxy)ethanol also known as butyl carbitol. Water-soluble CELLOSOLVE R viscosity modifiers are compounds of the 2-alkoxyethoxy ethanol class, with 2-butoxyethoxyethanol being preferred. Other suitable viscosity modifiers include benzyl alcohol, and diols such as 2-ethyl-1,3-hexanediol and 2,2,4-trimethyl-1,3-pentanediol and mixtures thereof. A preferred viscosity modifier for use herein is n-butoxypropoxypropanol.

The viscosity modifiers can also be selected from the group of compounds comprising ether derivatives of mono-, di- and tri-ethylene glycol, butylene glycol ethers, and mixtures thereof. The molecular weights of these viscosity modifiers are preferably less than 350, more preferably between 100 and 300, even more preferably between 115 and 250. Examples of preferred viscosity modifiers include, for example, mono-ethylene glycol n-hexyl ether, mono-propylene glycol n-butyl ether, and tri-propylene glycol methyl ether. Ethylene glycol and propylene glycol ethers are commercially available from the Dow Chemical Company under the tradename “Dowanol” and from the Arco Chemical Company under the tradename “Arcosolv”. Other preferred viscosity modifiers including mono- and di-ethylene glycol n-hexyl ether are available from the Union Carbide company.

When present the composition will preferably contain at least 0.01%, more preferably at least 0.5%, even more preferably still, at least 1% by weight of the composition of viscosity modifier. The composition will also preferably contain no more than 20%, more preferably no more than 10%.

These viscosity modifiers may be used in conjunction with an aqueous liquid carrier, such as water, or they may be used without any aqueous liquid carrier being present. Viscosity modifiers are broadly defined as compounds that are liquid at temperatures of 20° C.-25° C. and which are not considered to be surfactants. One of the distinguishing features is that viscosity modifiers tend to exist as discrete entities rather than as broad mixtures of compounds.

Diamines

Another optional although preferred ingredient of the compositions according to the present invention is a diamine. Since the habits and practices of the users of detergent compositions show considerable variation, the composition will preferably contain at least 0.1%, more preferably at least 0.2%, even more preferably, at least 0.25%, even more preferably still, at least 0.5% by weight of said composition of diamine. The composition will also preferably contain no more than 15%, more preferably no more than 10%, even more preferably, no more than 6%, even more preferably, no more than 5%, even more preferably still, no more than about 1.5% by weight of said composition of diamine.

Preferred organic diamines are those in which pK1 and pK2 are in the range of 8.0 to 11.5, preferably in the range of 8.4 to 11, even more preferably from 8.6 to 10.75. Preferred materials for performance and supply considerations are 1,3-bis(methylamine)-cyclohexane (pKa=10 to 10.5), 1,3 propane diamine (pK1=10.5; pK2=8.8), 1,6 hexane diamine (pK1=11; pK2=10), 1,3 pentane diamine (Dytek EP) (pK1=10.5; pK2=8.9), 2-methyl 1,5 pentane diamine (Dytek A) (pK1=11.2; pK2=10.0). Other preferred materials are the primary/primary diamines with alkylene spacers ranging from C4 to C8. In general, it is believed that primary diamines are preferred over secondary and tertiary diamines.

Definition of pK1 and pK2—As used herein, “pKa1” and “pKa2” are quantities of a type collectively known to those skilled in the art as “pKa” pKa is used herein in the same manner as is commonly known to people skilled in the art of chemistry. Values referenced herein can be obtained from literature, such as from “Critical Stability Constants: Volume 2, Amines” by Smith and Martel, Plenum Press, NY and London, 1975. Additional information on pKa's can be obtained from relevant company literature, such as information supplied by Dupont, a supplier of diamines. As a working definition herein, the pKa of the diamines is specified in an all-aqueous solution at 25° C. and for an ionic strength between 0.1 and 0.5 M.

Carboxylic Acid

The compositions according to the present invention may comprise a linear or cyclic carboxylic acid or salt thereof to improve the rinse feel of the composition. The presence of anionic surfactants, especially when present in higher amounts in the region of 15-35% by weight of the composition, results in the composition imparting a slippery feel to the hands of the user and the dishware. This feeling of slipperiness is reduced when using the carboxylic acids as defined herein i.e. the rinse feel becomes draggy.

Carboxylic acids useful herein include C1-6 linear or at least 3 carbon containing cyclic acids. The linear or cyclic carbon-containing chain of the carboxylic acid or salt thereof may be substituted with a substituent group selected from the group consisting of hydroxyl, ester, ether, aliphatic groups having from 1 to 6, more preferably 1 to 4 carbon atoms and mixtures thereof.

Preferred carboxylic acids are those selected from the group consisting of salicylic acid, maleic acid, acetyl salicylic acid, 3 methyl salicylic acid, 4 hydroxy isophthalic acid, dihydroxyfumaric acid, 1,2,4 benzene tricarboxylic acid, pentanoic acid and salts thereof and mixtures thereof. Where the carboxylic acid exists in the salt form, the cation of the salt is preferably selected from alkali metal, alkaline earth metal, monoethanolamine, diethanolamine or triethanolamine and mixtures thereof.

The carboxylic acid or salt thereof is preferably present at the level of from 0.1% to 5%, more preferably from 0.2% to 1% and most preferably from 0.25% to 0.5%.

Polymeric Suds Stabilizer

The compositions of the present invention may optionally contain a polymeric suds stabilizer. These polymeric suds stabilizers provide extended suds volume and suds duration without sacrificing the grease cutting ability of the liquid detergent compositions. These polymeric suds stabilizers are selected from:
i) homopolymers of (N,N-dialkylamino)alkyl acrylate esters having the formula: 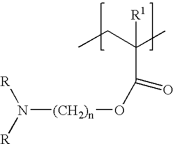
wherein each R is independently hydrogen, C₁-C₈ alkyl, and mixtures thereof, R¹ is hydrogen, C₁-C₆ alkyl, and mixtures thereof, n is from 2 to 6; and
ii) copolymers of (i) and 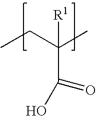
   wherein R¹ is hydrogen, C1-C6 alkyl, and mixtures thereof, provided that the ratio of (ii) to (i) is from 2 to 1 to 1 to 2; The molecular weight of the polymeric suds boosters, determined via conventional gel permeation chromatography, is from 1,000 to 2,000,000, preferably from 5,000 to 1,000,000, more preferably from 10,000 to 750,000, more preferably from 20,000 to 500,000, even more preferably from 35,000 to 200,000. The polymeric suds stabilizer can optionally be present in the form of a salt, either an inorganic or organic salt, for example the citrate, sulfate, or nitrate salt of (N,N-dimethylamino)alkyl acrylate ester.

One preferred polymeric suds stabilizer is (N,N-dimethylamino)alkyl acrylate esters, namely

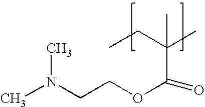

When present in the compositions, the polymeric suds booster may be present in the composition from 0.01% to 15%, preferably from 0.05% to 10%, more preferably from 0.1% to 5%, by weight.

Builder

The compositions according to the present invention may further comprise a builder system. If it is desirable to use a builder, then any conventional builder system is suitable for use herein including aluminosilicate materials, silicates, polycarboxylates and fatty acids, materials such as ethylene-diamine tetraacetate, metal ion sequestrants such as aminopolyphosphonates, particularly ethylenediamine tetramethylene phosphonic acid and diethylene triamine pentamethylene-phosphonic acid. Though less preferred for obvious environmental reasons, phosphate builders can also be used herein.

Suitable polycarboxylates builders for use herein include citric acid, preferably in the form of a water-soluble salt, derivatives of succinic acid of the formula R—CH(COOH)CH₂(COOH) wherein R is C₁₀₋₂₀ alkyl or alkenyl, preferably C₁₂₋₁₆, or wherein R can be substituted with hydroxyl, sulfo sulfoxyl or sulfone substituents. Specific examples include lauryl succinate, myristyl succinate, palmityl succinate 2-dodecenylsuccinate, 2-tetradecenyl succinate. Succinate builders are preferably used in the form of their water-soluble salts, including sodium, potassium, ammonium and alkanolammonium salts.

Other suitable polycarboxylates are oxodisuccinates and mixtures of tartrate monosuccinic and tartrate disuccinic acid such as described in U.S. Pat. No. 4,663,071.

Especially for the liquid execution herein, suitable fatty acid builders for use herein are saturated or unsaturated C₁₀₋₁₈ fatty acids, as well as the corresponding soaps. Preferred saturated species have from 12 to 16 carbon atoms in the alkyl chain. The preferred unsaturated fatty acid is oleic acid. Other preferred builder system for liquid compositions is based on dodecenyl succinic acid and citric acid.

If detergency builder salts are included, they will be included in amounts of from 0.5% to 50% by weight of the composition preferably from 0.5% to 25% and most usually from 0.5% to 5% by weight.

Enzymes

Detergent compositions of the present invention may further comprise one or more enzymes which provide cleaning performance benefits. Said enzymes include enzymes selected from cellulases, hemicellulases, peroxidases, proteases, gluco-amylases, amylases, lipases, cutinases, pectinases, xylanases, reductases, oxidases, phenoloxidases, lipoxygenases, ligninases, pullulanases, tannases, pentosanases, malanases, β-glucanases, arabinosidases or mixtures thereof. A preferred combination is a detergent composition having a cocktail of conventional applicable enzymes like protease, amylase, lipase, cutinase and/or cellulase. Enzymes when present in the compositions, at from 0.0001% to 5% of active enzyme by weight of the detergent composition. Preferred proteolytic enzymes, then, are selected from the group consisting of Alcalase® (Novo Industri A/S), BPN', Protease A and Protease B (Genencor), and mixtures thereof. Protease B is most preferred. Preferred amylase enzymes include TERMAMYL®, DURAMYL® and the amylase enzymes those described in WO 9418314 to Genencor International and WO 9402597 to Novo.

Magnesium Ions

The presence of magnesium ions in the detergent composition offers several benefits. Notably, the inclusion of such divalent ions improves the cleaning of greasy soils for various hand dishwashing liquid compositions, in particular compositions containing alkyl ethoxy carboxylates and/or polyhydroxy fatty acid amide. This is especially true when the compositions are used in softened water that contains few divalent ions. Preferably, the magnesium ions are added as a hydroxide, chloride, acetate, sulfate, formate, oxide or nitrate salt to the compositions of the present invention.

If they are to be included in an alternate embodiment of the present compositions, then the magnesium ions are present at an active level of from 0.01% to 1.5%, preferably from 0.015% to 1%, more preferably from 0.025% to 0.5%, by weight.

Chelating Agents

The detergent compositions herein may also optionally contain one or more iron and/or manganese chelating agents. Such chelating agents can be selected from the group consisting of amino carboxylates, amino phosphonates, polyfunctionally-substituted aromatic chelating agents and mixtures therein, all as hereinafter defined. Without intending to be bound by theory, it is believed that the benefit of these materials is due in part to their exceptional ability to remove iron and manganese ions from washing solutions by formation of soluble chelates.

Amino carboxylates useful as optional chelating agents include ethylene diamine tetracetates, N-hydroxy ethyl ethylene diamine triacetates, nitrilo-tri-acetates, ethylenediamine tetraproprionates, triethylene tetraamine hexacetates, diethylene triamine pentaacetates, and ethanol diglycines, alkali metal, ammonium, and substituted ammonium salts therein and mixtures therein.

Amino phosphonates are also suitable for use as chelating agents in the compositions of the invention when at lease low levels of total phosphorus are permitted in detergent compositions, and include ethylene diamine tetrakis (methylene phosphonates) as DEQUEST. Preferred, these amino phosphonates do not contain alkyl or alkenyl groups with more than 6 carbon atoms. Polyfunctionally-substituted aromatic chelating agents are also useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene. A preferred biodegradable chelator for use herein is ethylenediamine disuccinate (“EDDS”), especially the [S,S] isomer as described in U.S. Pat. No. 4,704,233, Nov. 3, 1987, to Hartman and Perkins. The compositions herein may also contain water-soluble methyl glycine diacetic acid (MGDA) salts (or acid form) as a chelant or co-builder. Similarly, the so called “weak” builders such as citrate can also be used as chelating agents.

If utilized, these chelating agents will generally comprise from 0.00015% to 15% by weight of the detergent compositions herein. More preferably, if utilized, the chelating agents will comprise from 0.0003% to 3.0% by weight of such compositions.

Other Ingredients—The detergent compositions will further preferably comprise one or more detersive adjuncts selected from the following: soil release polymers, polymeric dispersants, polysaccharides, abrasives, bactericides and other antimicrobials, tarnish inhibitors, dyes, buffers, antifungal or mildew control agents, insect repellents, perfumes, hydrotropes, thickeners, processing aids, suds boosters, brighteners, anti-corrosive aids, stabilizers antioxidants and chelants. A wide variety of other ingredients useful in detergent compositions can be included in the compositions herein, including other active ingredients, carriers, antioxidants, processing aids, dyes or pigments, solvents for liquid formulations, solid fillers for bar compositions, etc. If high sudsing is desired, suds boosters such as the C₁₀-C₁₆ alkanolamides can be incorporated into the compositions, typically at 1%-10% levels. The C₁₀-C₁₄ monoethanol and diethanol amides illustrate a typical class of such suds boosters. Use of such suds boosters with high sudsing adjunct surfactants such as the amine oxides, betaines and sultaines noted above is also advantageous.

An antioxidant can be optionally added to the detergent compositions of the present invention. They can be any conventional antioxidant used in detergent compositions, such as 2,6-di-tert-butyl-4-methylphenol (BHT), carbamate, ascorbate, thiosulfate, monoethanolamine(MEA), diethanolamine, triethanolamine, etc. It is preferred that the antioxidant, when present, be present in the composition from 0.001% to 5% by weight.

Various detersive ingredients employed in the present compositions optionally can be further stabilized by absorbing said ingredients onto a porous hydrophobic substrate, then coating said substrate with a hydrophobic coating. Preferably, the detersive ingredient is admixed with a surfactant before being absorbed into the porous substrate. In use, the detersive ingredient is released from the substrate into the aqueous washing liquor, where it performs its intended detersive function.

To illustrate this technique in more detail, a porous, hydrophobic silica (trademark SIPERNAT D10, DeGussa) is admixed with a proteolytic enzyme solution containing 3%-5% of C₁₃₋₁₅ ethoxylated alcohol (EO 7) nonionic surfactant. Typically, the enzyme/surfactant solution is 2.5× the weight of silica. The resulting powder is dispersed with stirring in silicone oil (various silicone oil viscosities in the range of 500-12,500 can be used). The resulting silicone oil dispersion is emulsified or otherwise added to the final detergent matrix. By this means, ingredients such as the aforementioned enzymes, bleaches, bleach activators, bleach catalysts, photoactivators, dyes, fluorescers, fabric conditioners and hydrolyzable surfactants can be “protected” for use in detergents, including liquid laundry detergent compositions.

Process of Cleaning Dishware

The present invention also relates to a process for cleaning dishware. The dishware is contacted with a composition as described above. The composition may be applied to the dishware neat or in dilute form. Thus the dishware may be cleaned singly by applying the composition to the dishware and optionally but preferably subsequently rinsing before drying. Alternatively, the composition can be mixed with water in a suitable vessel, for example a basin, sink or bowl and thus a number of dishes can be cleaned using the same composition and water (dishwater). In a further alternative process the product can be used in dilute form in a suitable vessel as a soaking medium for, typically extremely dirty, dishware. As before the dishware can be optionally, although preferably, rinsed before allowing to dry. Drying make take place passively by allowing for the natural evaporation of water or actively using any suitable drying equipment, for example a cloth or towel.

### EXAMPLES

The low temperature stability of compositions A and B was investigated.

Composition A represents a composition according to the present invention.

Composition B is a comparative detergent composition having a higher level of free alcohol.

| | A | B |
|---|---|---|
| Sasol AE3.0S⁽¹⁾ | 15.21 | |
| Natural AE3.0S⁽²⁾ | | 15.21 |
| Isalchem alkyl sulfate | 10.29 | 10.29 |
| anionic surfactant | | |
| Free fatty/sulfated | 1.92 | 3.33 |
| alcohol | | |
| Amine oxide | 8.5 | 8.5 |
| C10E8 nonionic | 7 | 7 |
| surfactant | | |
| Diamine | 0.5 | 0.5 |
| Ethanol | 3.5 | 3.5 |
| Sodium cumene | 3 | 3 |
| sulfonate | | |
| 1,4-Cyclohexane | 3.75 | 3.75 |
| dimethanol | | |
| pH | 7.5 | 7.5 |
| Viscosity | 150 cps | 150 cps |

⁽¹⁾alkyl ethoxylate sulfate with an average ethoxylation of 3, narrow EO distribution
⁽²⁾alkyl ethoxylate sulfate with an average ethoxylation of 3, broad EO distribution

Composition A was stable for 28 days at a temperature of −5° C.

Comparative composition B was not stable, and suffered from precipitation.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A dishwashing detergent composition comprising:
an alkyl ethoxylate sulfate surfactant having an average number of ethylene oxide units of from 1 to 5; and
from 1% to 8.5%, by weight of said composition, of amine oxide;
wherein said composition has a pH from 5.5 to 8.5, and said composition comprises a combined level of free fatty alcohols and sulfated alcohols of less than 3% by weight of said composition.

2. A dishwashing detergent composition according to claim 1 wherein said alkyl ethoxylate sulfate surfactant has an average number of ethylene oxide units of from 1 to 4.

3. A dishwashing detergent composition according to claim 1 wherein said alkyl ethoxylate sulfate surfactant has an average number of ethylene oxide units of from 1.5 to 3.5.

4. A dishwashing detergent composition according to claim 1 wherein the alkyl group of said alkyl ethoxylate sulfate surfactant has, on average, 12 to 14 carbon atoms.

5. A dishwashing detergent composition according to claim 1 wherein said alkyl ethoxylates sulfate surfactant has a narrow ethylene oxide distribution, wherein at least 50% by weight of the surfactant, contains polyethoxy groups which are within 3 ethoxy groups of the average number of ethylene oxide units.

6. A dishwashing detergent composition according to claim 1 wherein said amine oxide is present at a level from 5% to 8.5% by weight of said composition.

7. A dishwashing detergent composition according to claim 1 wherein said composition has a pH from 6 to 8.

8. A dishwashing detergent composition according to claim 1 wherein said combined level of free fatty alcohols and sulfated alcohols is less than 2% by weight of said composition.

9. A dishwashing detergent composition according to claim 1 wherein said free fatty alcohols and sulfated alcohols comprise alkyl units having from 8 to 18 carbon atoms.

10. A dishwashing detergent composition according to claim 1 wherein said amine oxide comprises a tertiary amine oxide.

11. A dishwashing detergent composition according to claim 1 wherein said amine oxide comprises a C₁₀-C₁₈ alkyl dimethyl amine oxide.

12. A dishwashing detergent composition according to claim 1 wherein said amine oxide comprises cocoamido-3-propyldimethylamine oxide.

13. A dishwashing detergent composition according to claim 1 wherein said composition is free of betaines.

14. A dishwashing detergent composition according to claim 1 wherein the weight ratio of amine oxide to alkyl ethoxy sulfate surfactant is of from 0.2 to 0.4.

15. A process of cleaning dishware, comprising the step of contacting said dishware with the dishwashing detergent composition, according to claim 1.
